(19) United States
(12) Patent Application Publication
(10) Pub. No.: US 2025/0281952 A1
(43) Pub. Date: Sep. 11, 2025

(54) Smart garbage collection, recycling, disposal and reuse system, for homes, cities, states and countries for comprehensive management, to recycle, reuse of all waste

(71) Applicant: Navtej Singh Dhillon, Supply, NC (US)

(72) Inventor: Navtej Singh Dhillon, Supply, NC (US)

(21) Appl. No.: 19/072,995

(22) Filed: Mar. 6, 2025

Related U.S. Application Data
(60) Provisional application No. 63/562,087, filed on Mar. 6, 2024.

(51) Int. Cl. B09B 3/00; B65F 1/00; B65F 1/06; B65F 1/14

(52) U.S. Cl. CPC B09B 3/00; B65F 1/0093; B65F 1/06; B65F 1/1468; B65F 2210/152

(57) ABSTRACT

Intend to invent and create, smart comprehensive garbage disposal and reuse system, comprising of many systems and sub-systems, to collect materials or garbage or waste or anything from homes, farms, cities, states and countries, and be able to identify, categorize and re-use them in an innovative way. The system intends to be much more efficient, comprehensive than an existing systems with it, novel new inventions and intends to solve the problem at a comprehensive level. The system will work at home level, transport level (e.g. truck or transmission), group of homes level, city town level, state level and country level, processing at each level for best efficiency and outcome.

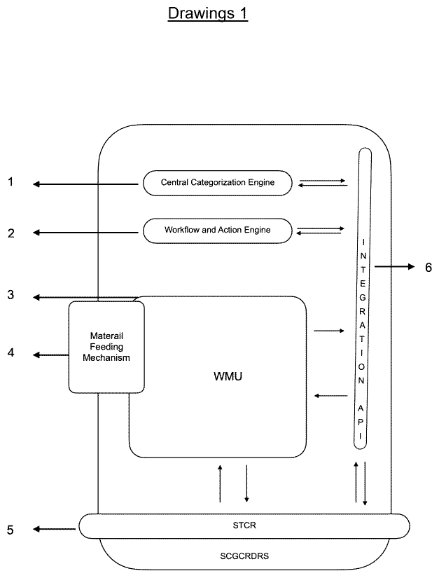

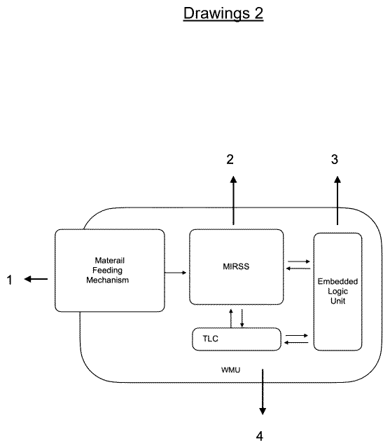

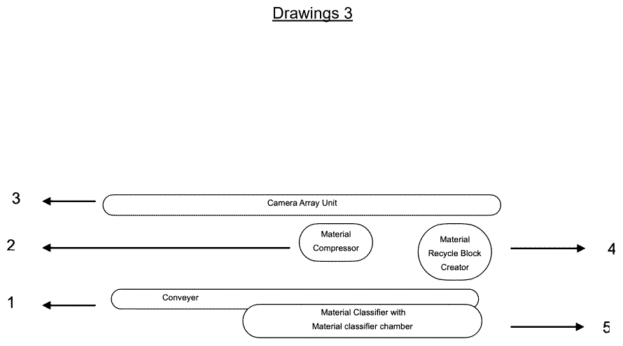

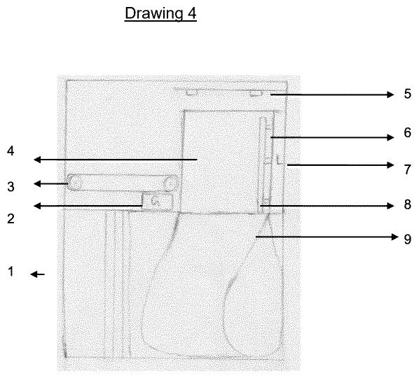

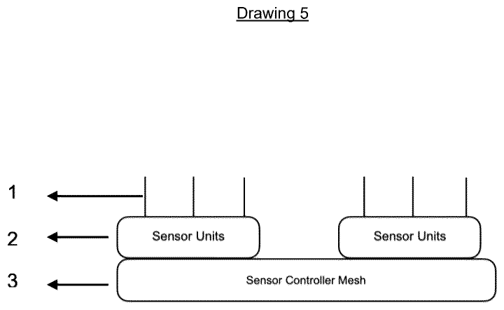

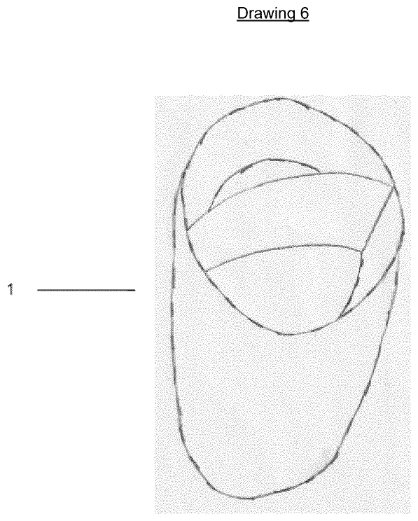

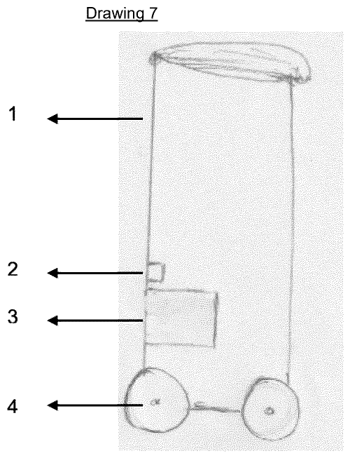

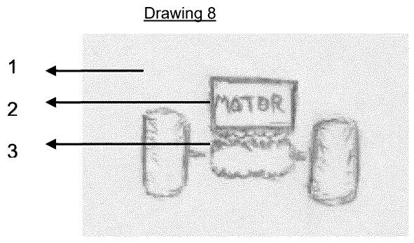

### CROSS-REFERENCE TO RELATED APPLICATIONS

63/562,087|—: Smart garbage collection, recycling, disposal and reuse system, for homes, cities, states and countries for comprehensive management and to recycle, reuse of all waste.

29/821,952|Design Application: BAG PARTITION, Pending

### STATEMENT REGARDING FEDERALLY SPONSORED RESEARCH OR DEVELOPMENT (IF APPLICABLE)

None

### BACKGROUND OF THE INVENTION

B.1 The invention is to create, a simple, holistic and smart garbage, material disposal and reuse system, for homes, cities, states and countries for comprehensive management and reuse of the waste, due to the problems that exists in the existing similar systems, and outlined below.

B.2 Current garbage disposal systems and waste management systems are inefficient and are not solving the problem.

B.3 The current systems do not solve the waste management holistically and significantly lack on how to reuse, process and re introduced the recycled waste back.

B.4 The current systems attempt to solve the problem for recycle the plastic, paper, aluminum only to some extent but significantly lacks to do that for all the population across the globe. The system is much harder to implement as it exists today, and even for the most developed nations it is not fully working to recycle all the waste materials.

B.5 Other than the materials mentioned above wastes and materials are significantly not handled

B.6 In current systems, the on for the recycling relies heavily on the proper use on the existing framework, guidelines and system, and not using so makes the existing systems inefficient.

B.7 In current systems, for plastic, paper, aluminum cans, there exists some recycling but exact categorization with long term handling and reuse is missing.

B.8 In current systems, other than plastic, paper, aluminum cans other wastes are not even recycled nor an attempt is made to do so for majority of the population.

B.9 Current systems use more than one garbage container, where one is handing the recycle material and the other container all other, this is huge limitation and significantly makes the system in-efficient. Also on the same lines there is one truck per garbage type which is a problem too.

B.10 No newer and innovative ways to solve this problem at holistic level has been introduced in the near past.

### Possible Class Classifications:

Computers, Data and IT: Class 702, 703, 700, 701, 702, 709
Organics: Class 435, 530, 800
Inorganic: Class 423
Class: 136
Class: 260

### BRIEF SUMMARY OF THE INVENTION

B. Intend to invent and create, smart garbage, material disposal and reuse system, for homes, cities, states and countries for comprehensive management and reuse of the waste, introduces smartness to garbage and material disposal system.

B.1 The system will introduce smartness at different levels in the wastage journey, and smart waste processing units that work on these levels, rather than waiting to reach a particular facility and will re-introduce recycled or reused materials back at that level. The smartness will be in the identification, categorization, management, recycling and re introduction at that level with the use of smart waste processing units powered by the de centralized system as described in detail in the description.

B.2 Levels for smart processing and decision will be at home level, transport level (e.g. truck or smart transmission), group of homes level, city town level, state level and country level, processing at each level for best efficiency and outcome.

B.3 System will put more ons on the system for its proper working and assist the user as much as possible making the system highly efficient.

B.4 System will process all the waste and will recycle all of it with the aim of 100% of the waste recycle and re-use and re introduce.

B.5 System will be simpler and economical with optional use of partitioned bags, eliminating the need for multi-container and multi carrier (trucks) and multi-processing logic

B.6 System is based on latest computer, hardware, devices, IT, data processing, manufacturing, plug and play, decentralized processing models, and working repeatable pattern where one unit will be a collective work, and combining the smaller units will be do the work at bigger level.

B.7 Doing so the system will following advantages:

B.8 The system will achieve much higher level of recycling percentage as it will recycle almost all of the waste and not limited to some.

B.9 The system though smarter but will be more simpler to operate, for the user and energy efficient

B.10 The system will re-introduce food or food waste or meat waste wastes as recycled tablets (WRFT) at every stage and will act as life line for wild animals and marine life, which might result significant population increase for animals and marine population benefiting human population very significantly also.

B.11 The system will re-introduce food or food waste or meat waste as very fertile manure (WRM), which will significantly increase farming yield and more means to organic farming.

B.12 The system will create future oriented deports and interlink systems, like “Plastic Deport” and other material deports, which may become a major source of materials in the years to come.

B.13 The system will create local parks, forest, wild re-use sites (SLPFRS) and create smart marine re-use sites (SMRS), which will create significant wild life increase.

### BRIEF DESCRIPTION OF THE SEVERAL VIEWS OF THE DRAWING

DW.1 Drawing 1: Smart garbage collection, recycling, disposal and reuse system SCGCRDRS.

DW.1.1 Drawing 1: Smart garbage collection, recycling, disposal and reuse system SCGCRDRS. Smart comprehensive garbage collection, recycle, disposal and reuse system (SCGCRDRS), comprises of garbage processing devices, garbage processing apparatus, computer hardware components, microchip hardware components, computer software components, computer API, computer aided object classification, garbage management at different level as SAAS, transportation enhancements to garbage transporters and new smart transmission lines for directly feeding the recycled waste back into the environment, Further as depicted in D.1

DW.1.2 1 “Central categorization engine”, is the central repository and expert system for all the categorization of the different waste material with the attached characteristics, attributes, and spherically algorithmic bindings to the photographic categorization of different waste materials. The systems as such works with different emu types, and works in tandem with workflow and action engine for each different categorization of the waste material. The system caches in information in WMU and accordingly updates the repository based on the new information from the wmu's.

DW.1.3 2 “Workflow and action engine”, SCGCRDRS in unique in its logic as all the workflow and the actions of the comprising components in derived as workflows, and actions. This workflow and action map is stored for each WMU and sent to the WMU, further based on the different categorization of the of the categorization engine the workflow action engine changes it configuration for wmu or particular waste that is being processed.

DW.1.4 3 is “Waste management unit”, is the central unit of the system as is further described in Drawing DW.2 and section D.2.

DW.1.5 4 is “Material Feeding Mechanism” is the customizable apparatus that are attached to the wmu to feed the waste materials, the simplest feeding mechanism is just an opening, and other ones being conveyer belt, further with the modular design more complex mechanisms can be added as needed.

DW.1.6 5 is “STCR” is smart transmission (with smart pipes and smart carrier devices) collection and re-use, particularly STCR is takes the recycled waste food in non solid form and delivers to organic manure regeneration sites, where the smart carrier devices are responsible for carrying solid food tablets to the SMRS and forest sites.

DW.1.7 6 is “Integration API” is the central API which connects all the systems as sub systems, and various components, the system as a whole is created with the API first approach, with each system sub system have dedicated endpoints.

DW.2 Drawing 2: Wastage Management Unit (WMU) logical diagram.

DW.2.1 Drawing 2: Wastage Management Unit (WMU) logical diagram. WMU is the smallest unit with complete functionality to process garbage at that particular level. Based on the level on which WMU operates it can have more or less functionality and can process garbage based on different categorizations. Further as described in D.2.

DW.2.2 1 is “Material Feeding Mechanism” is the customizable apparatus that are attached to the wmu to feed the waste materials, the simplest feeding mechanism is just an opening, and other ones being conveyer belt, further with the modular design more complex mechanisms can be added as needed.

DW.2.3 2 “MIRSS” is material (or food waste) identification and recovery sub system (MIRSS). Further as described in drawing D3 and section D.4.

DW.2.4 3 “Embedded logic Unit” is microcontroller processing unit (such as raspberry pi), which has computational logic and ability to connect to wifi and further be able to connect to the central system.

DW.2.5 4 “TLC” is toxic level checker, which consists of censor mesh, and probing censor probes, in one implementation embedded in the conveyer belt, and in the material classification chamber with sensors with the ability to detect the toxic of the food waste or other toxic materials. The system as such uses TLC to determine if the food waste should be reproduced as food wastage tablets or should sent as manure or discarded as waste.

DW.3 Drawing 3: Material (or food waste) identification and recycle sub system (MIRSS) logical diagram

DW.3.1 Drawing 3: Material (or food waste) identification and recycle sub system (MIRSS), this subs system is critical part of the wmu and can come with various implementations based on the level at which it is deployed at. The simple implementation is at the home level, with least amount of components and at other levels, such as transport, a waste management facility or group of houses the implementation has more components, though the basic design is same, and logic is governed by central system.

DW.3.2 1 “Conveyer” is the conveyer belt with two sub belts system, one with the initial part and the second on with material classifier with the material classifier chamber. The converter belt is the mechanism for moving the garbage, sorting it, classification and henceforth.

DW.3.3 2 “Material Compressor” compresses the material, or food waste after the material to be compressed is separated, and has been rightly classified to be compressed.

DW.3.4 3 “Camera Array Unit” is the array of cameras which is used to activity used to classify the waste material or food waste, and using the central system it further uses the classification and material classifier chamber.

DW.3.5 4 “Material Recycle Block Creator”, the material recycle block creator actively creates the waste material blocks or waste food tablets, or uses the STCR, to re introduce the waste food or material back.

DW.3.6 5 “Material classifier with material classifier chamber”, is the chamber which is used to classify the material, using the camera array and central categorization engine, further based on the actions of the system as such does the right actions on the material.

DW.4 Drawing 4: Simple example implementation of wastage management unit (WMU) for traditional two garbage bags.

DW.4.1 Drawing 4: Shows a very simple example implementation of the prototype wastage management unit using tradition two garbage bags. Where as the implementation is much more efficient while using two multi partition garbage bags.

DW.4.2 1: Simple example implementation of wastage management unit (WMU) for traditional two garbage bags.

DW.4.3 2: “Governor” is motor unit with active wires and pulling mechanism which controls the conveyer belt, material compressor unit, bag selector sleeve, and active material operation gate.

DW.4.4 3: “Conveyer” is the conveyer belt.

DW.4.5 4: is Material classifier with material classifier chamber

DW.4.4 5: is Camera Array Unit

DW.4.4 6: is Material Compressor.

DW.4.4 7: is Embedded logic Unit

DW.4.4 8: is TLC

DW.4.4 9: Material Recycle Block Creator

DW.5 Drawing 5: Toxic level checker (TLC) sub system.

DW.5.1 Drawing 5: “TLC” is toxic level checker, which consists of censor mesh, and probing censor probes, in one implementation embedded in the conveyer belt, and in the material classification chamber with sensors with the ability to detect the toxic of the food waste or other toxic materials. The system as such uses TLC to determine if the food waste should be reproduced as food wastage tablets or should sent as manure or discarded as waste.

DW.5.2 1: “Censor Probes” is the censor probes end which sensors use to detect and sense the material and toxic level they are trying to sense.

DW.5.2 2: “Sensor Units” are the sensors that are used in a mesh to detect different types of types of toxic substances.

DW.5.2 3: “Sensor control mesh”, is the mesh which is responsible for the activation of sensors, setting the right sensitivity and using the categorization system use the right calibration to detect the toxic level and signal to do the appropriate action.

DW.6 Drawing 6: Garbage bag with two partitions.

DW.6.1 Drawing 6: Garbage bag with two partition.

DW.6.2 1: Is garbage bag with two partitions. On the same lines, a garbage bag can have three or at the most four partitions. Where the idea being one partition will be used for kind of waste and the other for other. For example one partition can be used for normal waste and other partition can be used for recycle, and if there are three partitions the third partition can be specifically used for organic or food waste.

DW.7 Drawing 7: Battery or electric operated, self propelled garbage containers (BEOSPGC).

DW.7.1 Drawing 7: Battery or electric operated, self propelled garbage containers (BEOSPGC).

DW.7.2 1: Is the self propelled garbage container, which is any traditional garbage container with built in electric motor, where the electric motor can be either powered by the direct electric line, or battery comportment. Further the electric motor has self assist mechanism, where the motor can start push automatically with the detection of the motion and can assist in propelling.

DW.7.2 2: “Power Outlet” is the power outlet which can be used to either charge the battery or use an active wire to propel the garbage container.

DW.7.2 3: “Battery” is the battery compartment to hold the battery.

DW.8 Drawing 8: Self propelling mechanism of BEOSPGC.

DW.8.1 Drawing 8: Self propelling mechanism of self propelled garbage containers.

DW.8.2 1: Is the sectional view of the self propelling mechanism of self propelled garbage containers.

DW.8.2 2: “Motor” is the electric motor, which drives the wheels and has the motion detection activation technology. Using the active motion detection on activation technology no button is needed as such, and the motor can detect as small motion and can assist in propelling the garbage container forward.

DW.8.2 3: “Axle” is the axle which diverts the power from the motor to the wheels.

### DESCRIPTION

### Detailed Description of the Invention

P Intend to invent and create, smart garbage, material disposal and reuse system, for homes, cities, states and countries for comprehensive management and reuse of the waste, introduces smartness to garbage and material disposal system. The system introduces smartness at different levels in the wastage journey, and smart waste processing units that work on these levels, rather than waiting to reach a particular facility and re-introduces recycled or reused materials back at that level. The smartness is in the identification, categorization, management, recycling and re introduction at that level with the use of smart waste processing units powered by the de centralized system as described in detail in the description.

P.1 Levels for smart processing and decision are at home level, transport level (e.g. truck or smart transmission), group of homes level, city town level, state level and country level, processing at each level for best efficiency and outcome. System puts more ons on the system for its proper working and assist the user as much as possible in making the system highly efficient. System will process all the waste and will recycle all of it with the aim of 100% of the waste recycle and re-use and re introduce it.

P.2 System is simpler and economical with optional use of partitioned bags, eliminating the need for multi-container and multi carrier (trucks) an. As system is based on latest computer, hardware, devices, IT, data processing, manufacturing, plug and play, decentralized processing models, and works on repeatable pattern where one unit does complete collective work, and combining the smaller units do the work at bigger level.

P.3 The system achieves much higher level of recycling percentage as it recycles almost all of the waste and not limited to some. The system though smarter but is more simpler to operate, for the user and energy is efficient holistically. The holistically is achieved in part by the operation of the system where the need for say multiple trucks is eliminated and also the very nature to process all waste and also to reintroduce the waste much earlier than later makes the system holistically much more energy efficient.

P.4 The system re-introduces food or food waste or meat waste wastes as recycled tablets (WRFT) at every stage and acts as life line for wild animals and marine life, which might result significant population increase for animals and marine population benefiting human population significantly. Also the system re-introduces food or food waste or meat waste as very fertile manure (WRM), which will significantly increase farming yield and more means to organic farming.

P.5 The system intent to create future oriented deports and interlink systems, like “Plastic Deport” and other material deports, which may become a major source of materials in the years to come. The system will create smart local parks, forest, wild re-use sites (SLPFRS) and create smart marine re-use sites (SMRS), which may create significant wild life increase.

P.6 Smart comprehensive garbage collection, recycle, disposal and reuse system (SCGCRDRS), comprises of garbage processing devices, garbage processing apparatus, computer hardware components, microchip hardware components, computer software components, computer API, computer aided object classification, garbage management at different level as SAAS, transportation enhancements to garbage transporters and new smart transmission lines for directly feeding the recycled waste back into the environment.

P.7 At the center of the smart comprehensive garbage collection, recycle, disposal and reuse system (SCGCRDRS) is wastage management unit (WMU), which is driven by repeatable different modules as described further. WMU is the smallest unit with complete functionality to process garbage at that particular level. Based on the level on which WMU operates it can have more or less functionality and can process garbage based on different categorizations. WMU can be small enough to be hosted in a single home or can be hosted in a moving truck or can be large enough to be hosted city wide facility, as there is separation of the unit and devices that make up the whole device, and the logic which makes drives these devices.

P.8 Wastage management unit (WMU), is a garbage collection apparatus with smaller hardware devices, microcontroller processing unit (as raspberry pi), food waste and material identification and recycle module “MIRSS”, toxic level checker “TLC” and other components, as described in detail in detailed working.

P.9 The WMU can work with traditional garbage bags as the garbage they exists today or can work with portioned bags (PB) s or multi partitioned bags. The use of portioned or multi partitioned bags make the system highly effective.

P.10 With WMU's ability to process waste, it processes the food waste and creates food waste tablets or food waste manure, which can be re introduced in the system very readily.

P.11 WMU further uses smart garbage collection transport (SGCT) with dual role of collection, processing and distribution of food waste tablets and waste manure.

P.12 The system also create smart transmission (with smart pipes and smart carrier devices) collection and re-use (STCR) system for the distribution of food waste tablets and waste manure.

P.13 The system lays the foundation to create sites where these processed waste food tablets and materials can be stored, introduced back to the environment, creating lifelines for other species, by creating wild re-use sites (SLPFRS), smart marine re-use sites (SMRS) for food waste tablets and plastic deports, material deports for other recycled materials.

P.14 As the goal of the system is to achieve highest Interoperability, the libraries of the system is implemented in multiple programming languages. The first implementation being in with native functionality in C, C++, VC++ and subsequently in python, then java, c #, objective c. The interfaces written in cross platform frameworks, with mobile responsive and AR/VR convertible. The system is also resized as firmware, adapter agent, server application, mobile application, tablet application, AR/VR application, web application, desktop application, router firmware, switch firmware, hub firmware. There are two modes of invoking the system, one being the API interface of “Plug and Play” interface of the system, the other being implementation is the native implementation, where the libraries, firmwares are created, and embedded in the device OS and OEM. For all the functionality for all the modules are developed with SOA (service oriented architecture) with the API first approach with public, protected and private interfaces, these interfaces further makes the system very highly interoperable. Giving the system to simultaneously hosted on prem, data centers, and its own public cloud, for the UI interfaces, broker and managing of the waste management systems and system as such. The system uses other existing frameworks for mobile, tablet and AR/VR. The system also uses mysql, Postgres, file system along with very secure hash safe custom native persistent data structures, and data lake. Also as the system is implemented as SAAS in multi region, communication between its different multi region SAAS, across different geographies and countries.

### P.15 Glossary

SCGCRDRS: Smart comprehensive garbage collection, recycle, disposal and reuse system.
WMU: wastage management unit (WMU)
MIRSS: Material (or food waste) identification and recycle sub system
TLC: Toxic level checker (TLC) sub system.
AGBL: Automatic garbage bag loader
BEOSPGC: Battery or electric operated, self propelled garbage containers
SGCT: smart garbage collection transport (SGCT).
STCR: smart transmission (with smart pipes and smart carrier devices) collection and re-use
SLPFRS: smart local parks, forest, wild re-use sites

### D.1 Detailed Description and Working of SCGCRDRS

D.1.1 Smart comprehensive garbage collection, recycle, disposal and reuse system (SCGCRDRS), comprises of garbage processing devices, garbage processing apparatus, computer hardware components, microchip hardware components, computer software components, computer API, computer aided object classification, garbage management at different level as SAAS, transportation enhancements to garbage transporters and new smart transmission lines for directly feeding the recycled waste back into the environment, further as described in each section.

D.1.2 At the center of the smart comprehensive garbage collection, recycle, disposal and reuse system (SCGCRDRS) is wastage management unit (WMU), which is driven by repeatable different modules as described further.

D.1.3 Drawing 1: Smart garbage collection, recycling, disposal and reuse system SCGCRDRS.

D.1.4 1 “Central categorization engine”, is the central repository and expert system for all the categorization of the different waste material with the attached characteristics, attributes, and spherically algorithmic bindings to the photographic categorization of different waste materials. The systems as such works with different emu types, and works in tandem with workflow and action engine for each different categorization of the waste material. The system caches in information in WMU and accordingly updates the repository based on the new information from the wmu's.

D.1.5 2 “Workflow and action engine”, SCGCRDRS in unique in its logic as all the workflow and the actions of the comprising components in derived as workflows, and actions. This workflow and action map is stored for each WMU and sent to the WMU, further based on the different categorization of the of the categorization engine the workflow action engine changes it configuration for wmu or particular waste that is being processed.

D.1.6 3 is “Waste management unit”, is the central unit of the system as is further described in section D.2.

D.1.7 4 is “Material Feeding Mechanism” is the customizable apparatus that are attached to the wmu to feed the waste materials, the simplest feeding mechanism is just an opening, and other ones being conveyer belt, further with the modular design more complex mechanisms can be added as needed.

D.1.8 5 is “STCR” is smart transmission (with smart pipes and smart carrier devices) collection and re-use, particularly STCR is takes the recycled waste food in non solid form and delivers to organic manure regeneration sites, where the smart carrier devices are responsible for carrying solid food tablets to the SMRS and forest sites.

D.1.9 6 is “Integration API” is the central API which connects all the systems as sub systems, and various components, the system as a whole is created with the API first approach, with each system sub system have dedicated endpoints.

### D.2 Detailed Description and Working of WMU

D.2.1 WMU is the smallest unit with complete functionality to process garbage at that particular level. Based on the level on which WMU operates it can have more or less functionality and can process garbage based on different categorizations. WMU can be small enough to be hosted in a single home or can be hosted in a moving truck or can be large enough to be hosted city wide facility, as there is separation of the unit, hardware, devices that make up the whole device, and the logic, which makes the working very unique and be able to work at different scales.

D.2.2 Wastage management unit (WMU), is a garbage collection apparatus with hardware devices, microcontroller processing unit (as raspberry pi), food waste and material identification and recycle module “MIRSS”, toxic level checker “TLC” and other components, as described in detail in the diagram description.

D.2.3 The WMU works with traditional garbage bags as the garbage they exists today or can work with portioned bags (PB) s or multi partitioned bags. The use of portioned or multi partitioned bags make the system highly effective.

D.2.4 The WMU relies on the “Integration API” for both its communication with the “Categorization Engine” which is responsible for categorization of different waste materials and “Workflow and action engine” which is responsible for creating the workflow of different components of WMU and

D.2.5 Drawing 2: Wastage Management Unit (WMU) logical diagram. WMU is the smallest unit with complete functionality to process garbage at that particular level. Based on the level on which WMU operates it can have more or less functionality and can process garbage based on different categorizations. Further as described in D.2.

D.2.6 1 is “Material Feeding Mechanism” is the customizable apparatus that are attached to the wmu to feed the waste materials, the simplest feeding mechanism is just an opening, and other ones being conveyer belt, further with the modular design more complex mechanisms can be added as needed.

D.2.7 2 “MIRSS” is material (or food waste) identification and recovery sub system (MIRSS). Further as described in drawing D3 and section D.4.

D.2.8 3 “Embedded logic Unit” is microcontroller processing unit (such as raspberry pi), which has computational logic and ability to connect to wifi and further be able to connect to the central system.

D.2.9 4 “TLC” is toxic level checker, which consists of censor mesh, and probing censor probes, in one implementation embedded in the conveyer belt, and in the material classification chamber with sensors with the ability to detect the toxic of the food waste or other toxic materials. The system as such uses TLC to determine if the food waste should be reproduced as food wastage tablets or should sent as manure or discarded as waste.

D.2.10 WMU can be customized by adding more device tor less devices to its implementation, so that WMU can work for homes, or can work for group of homes, or can work at transport level, inside a garbage truck or transmission level. On the same lines the system as such can work on city, town, state or country level.

D.2.11 Further using the classification codes on the garbage bags signifying the level of processing of the garbage, at each up level the next set or processing is done or is not done, the preliminary codes are mentioned in D.6.

### D.3 Detailed Description and Working of MIRSS

D.3.1 Material (or food waste) identification and recycle sub system (MIRSS), this subs system is critical part of the wmu and can come with various implementations based on the level at which it is deployed at. The simple implementation is at the home level, with least amount of components and at other levels, such as transport, a waste management facility or group of houses the implementation has more components, though the basic design is same, and logic is governed by central system.

D.3.2 The material here is a generalization and can be any material, and when the system working on food waste, the system as such will be able to Able to identify any food or food waste or meat waste or bio living substance from other materials. Be able Be able to extract the found food or bio living substance. Be able to classify the found food waste. Be able to check the toxic level using the “TLC” (Toxic Level Checker) and Be able to convert the non toxic found food or food waste or meat waste or bio living substance into, waste recycled food tablets of different classifications for animal consumption or waste recycled manure (WRM).

D.3.3 Drawing 3: Material (or food waste) identification and recycle sub system (MIRSS).

D.3.4 1 “Conveyer” is the conveyer belt with two sub belts system, one with the initial part and the second on with material classifier with the material classifier chamber. The converter belt is the mechanism for moving the garbage, sorting it, classification and henceforth.

D.3.5 2 “Material Compressor” compresses the material, or food waste after the material to be compressed is separated, and has been rightly classified to be compressed.

D.3.6 3 “Camera Array Unit” is the array of cameras which is used to activity used to classify the waste material or food waste, and using the central system it further uses the classification and material classifier chamber.

D.3.7 4 “Material Recycle Block Creator”, the material recycle block creator actively creates the waste material blocks or waste food tablets, or uses the STCR, to re introduce the waste food or material back.

### D.4 Detailed Description and Working of TLC

D.4.1 “TLC” is toxic level checker, which consists of censor mesh, and probing censor probes, in one implementation embedded in the conveyer belt, and in the material classification chamber with sensors with the ability to detect the toxic of the food waste or other toxic materials. The system as such uses TLC to determine if the food waste should be reproduced as food wastage tablets or should sent as manure or discarded as waste

D.4.2 1: “Censor Probes” is the censor probes end which sensors use to detect and sense the material and toxic level they are trying to sense.

D.4.3 2: “Sensor Units” are the sensors that are used in a mesh to detect different types of toxic substances.

D.4.4 3: “Sensor control mesh”, is the mesh which is responsible for the activation of sensors, setting the right sensitivity and using the categorization system use the right calibration to detect the toxic level and signal to do the appropriate action.

### D.5 Detailed Description and Working of BEOSPGC

D.5.1 Battery or electric operated, self propelled garbage containers (BEOSPGC).

D.5.2 Drawing 7: Battery or electric operated, self propelled garbage containers (BEOSPGC).

D.5.3 1: Is the self propelled garbage container, which is any traditional garbage container with built in electric motor, where the electric motor can be either powered by the direct electric line, or battery comportment. Further the electric motor has self assist mechanism, where the motor can start push automatically with the detection of the motion and can assist in propelling.

D.5.4 2: “Power Outlet” is the power outlet which can be used to either charge the battery or use an active wire to propel the garbage container.

D.5.5 3: “Battery” is the battery compartment to hold the battery.

D.5.6 Drawing 8: Self propelling mechanism of self propelled garbage containers.

D.5.8 1: Is the sectional view of the self propelling mechanism of self propelled garbage containers.

D.5.9 2: “Motor” is the electric motor, which drives the wheels and has the motion detection activation technology. Using the active motion detection on activation technology no button is needed as such, and the motor can detect as small motion and can assist in propelling the garbage container forward.

D.5.10 3: “Axle” is the axle which diverts the power from the motor to the wheels.

### D.6 Detailed Description and Working of Multi Partition Garbage Bags

D.6.1 Is garbage bag with two partitions, bi-partition bag (compartment) or tri-partition bag (compartment) or four-partition bags. Having multi portions of the bag significantly improves the efficiency of the system as such.

D.6.2 This unique feature of multi partitions makes the whole system super efficient, as using only one bag, multiple types of garbage can be handled. Further with the barcode and color coding, it can actively signify as to the state of the garage in the bags. Signifying, what processing needs to happen at different levels. Further the need for multiple containers is eliminated, and also need for multiple trucks which are needed to transport different kind of garbage is eliminated as only one bag can handle multiple type of garbage.

D.6.3 Following are preliminary codes. Which are embedded on the garbage bags, so the system can recognize the codes
RW—Raw unprocessed unclassified waste
RO—Raw organic unclassified waste
RR—Raw recyclable waste
PR—Processed recyclable waste
PW—Processed unclassified waste
PO—Processed organic waste

D.6.4 Drawing 4: Garbage bag with two partition.

D.6.5 1: Is garbage bag with two partitions. On the same lines, a garbage bag can have three or at the most four partitions. Where the idea being one partition will be used for kind of waste and the other for other. For example one partition can be used for normal waste and other partition can be used for recycle, and if there are three partitions the third partition can be specifically used for organic or food waste.

### D.7 Detailed Description and Working of SGCT

D.7.1 smart garbage collection transport (SGCT) with dual role, of collection, processing and distribution of FBLIR, WRM. The concept is realized with the transport has active WMU in them and can actively, create the processed food waste tablets, and material can the same trucks can introduce them back into the sites.

### D.8 Detailed Description and Working of STCR

D.8.1 “STCR” is smart transmission (with smart pipes and smart carrier devices) collection and re-use, particularly STCR is takes the recycled waste food in non solid form and delivers to organic manure regeneration sites, where the smart carrier devices are responsible for carrying solid food tablets to the SMRS and forest sites

### D.9 Detailed Description and Working of PD, MD, SLPFRS and SMRS

D.9.1 PD are specialized plastic deports and MD are specialized material deports for particular recycled material. And SLPFRS are special created zones for smart local parks, forest, wild re-use sites and SMRS are smart marine re-use sites.

D.10 Detailed Description with Architectural Diagrams and Drawings, Working of Different Sub Systems, Systems and Interactions Between them

D.10.1 As the goal of the system is to achieve highest Interoperability, the libraries of the system is implemented in multiple programming languages. The first implementation being in with native functionality in C, C++, VC++ and subsequently in python, then java, c #, objective c. The interfaces written in cross platform frameworks, with mobile responsive and AR/VR convertible. The system is also resized as firmware, adapter agent, server application, mobile application, tablet application, AR/VR application, web application, desktop application, router firmware, switch firmware, hub firmware. There are two modes of invoking the system, one being the API interface of “Plug and Play” interface of the system, the other being implementation is the native implementation, where the libraries, firmwares are created, and embedded in the device OS and OEM. For all the functionality for all the modules are developed with SOA (service oriented architecture) with the API first approach with public, protected and private interfaces, these interfaces further makes the system very highly interoperable. Giving the system to simultaneously hosted on prem, data centers, and its own public cloud, for the U interfaces, broker and managing of the waste management systems and system as such. The system uses other existing frameworks for mobile, tablet and AR/VR. The system also uses mysql, Postgres, file system along with very secure hash safe custom native persistent data structures, and data lake. Also as the system is implemented as SAAS in multi region, communication between its different multi region SAAS, across different geographies and countries.

1: Claim to invent and create, comprehensive garbage collection, recycle, disposal and reuse system (SCGCRDRS), comprising of many systems and sub-systems, to collect materials or garbage or waste or any material, from homes, farms, cities, states and countries, and be able to identify, categorize and re-use it in an innovative way.

2: Claim to invent and create a new “Wastage Management Unit (WMU)” to be hosted in a location (home or farm or a commercial facility or moving vehicle), with material (or food waste) identification and recovery sub system (MIRSS), toxic level checker (TLC) sub system, which will to check the toxic level based on levels defined for a material, to create recycled material (or food) tablets.

3: Claim to invent and create a new bi-partition garbage bag (compartment) or tri-partition garbage bag (compartment) or four partition garbage bag (Partitioned Bags) (PB) s.

4: Claim to invent to create battery or electric operated, self propelled garbage containers (BEOSPGC), which can move automatically with the push of button.
